(19) United States
(12) Patent Application Publication
(10) Pub. No.: US 2025/0136108 A1
(43) Pub. Date: May 1, 2025

(54) CONTEXTUAL ADAPTIVE CRUISE CONTROL SYSTEM FOR A VEHICLE NAVIGATING A HILL

(71) Applicant: GM Global Technology Operations LLC, Detroit, MI (US)

(72) Inventors: Mohamed A. Layouni, Fraser, MI (US); Markus Jochim, Troy, MI (US)

(21) Appl. No.: 18/494,090

(22) Filed: Oct. 25, 2023

(51) Int. Cl. B60W 30/14; B60W 20/13; B60W 40/06; B60W 40/09; B60W 40/105; B60W 40/13; G06N 3/02

(52) U.S. Cl. CPC B60W 30/143; B60W 20/13; B60W 40/06; B60W 40/09; B60W 40/105; B60W 40/13; G06N 3/02; B60W 2530/10; B60W 2552/15; B60W 2552/40; B60W 2556/40; B60W 2556/45; B60W 2710/083

(57) ABSTRACT

A contextual adaptive cruise control system for a vehicle includes one or more controllers in electronic communication with a plurality of perception sensors and a prime mover. The one or more controllers execute instructions to receive perception data from the plurality of perception sensors. The one or more controllers determine a longitudinal incline of the roadway that vehicle is presently traveling along based on the perception data, compare the longitudinal incline to a threshold incline value saved in memory, and in response to determining the longitudinal include is at least equal to the threshold incline value, determine the vehicle is climbing a hill. The one or more controllers instruct the contextual adaptive cruise control system to modify a behavior of the vehicle based on at least one of a target speed of the vehicle and an output torque of the prime mover of the vehicle.

### INTRODUCTION

The present disclosure relates to a contextual adaptive cruise control system that modifies the behavior of a vehicle based on a target speed of the vehicle, an output torque of a prime mover of the vehicle, or both the target speed and the output torque as the vehicle navigates a hill.

Many vehicles include various driver assistance systems that support a driver in a variety of ways. For example, adaptive cruise control (ACC) systems may relieve drivers from routine longitudinal vehicle control by ensuring the host vehicle is an acceptable headway distance from a vehicle that immediately precedes the ego vehicle, which is referred to as the preceding vehicle. Adaptive cruise control systems determine movement of an ego vehicle based on the movement of the preceding vehicle and a target speed.

Adaptive cruise control systems attempt to accelerate the vehicle such that the target speed is reached relatively quickly. Thus, when the vehicle climbs a hill, this behavior results in the vehicle experiencing relatively high levels of jerk, which is a rate of change in an object's acceleration. Some occupants may find the relatively high level of jerk objectionable. An occupant may apply the brakes to disengage the adaptive cruise control and to reduce the speed of the vehicle in an effort to alleviate the jerking. However, applying the brakes reduces the fuel or energy economy of the vehicle. Furthermore, it is also to be appreciated that when the vehicle drives down a hill, the speed of the vehicle increases due to gravity. The speed of the vehicle continues to increase in speed until surpassing the target speed. The adaptive cruise control system then applies the brakes to reduce the speed of the vehicle, even if there is no obstacle present in front of the vehicle, which in turn reduces the energy efficiency of the vehicle.

Thus, while adaptive cruise control systems achieve their intended purpose, there is a need in the art for an improved approach to control the behavior of a vehicle when navigating a hill.

### SUMMARY

According to several aspects, a contextual adaptive cruise control system for a vehicle is disclosed. The vehicle includes a prime mover and a plurality of perception sensors. The contextual adaptive cruise control system includes one or more controllers in electronic communication with the plurality of perception sensors and the prime mover. The one or more controllers execute instructions to receive perception data from the plurality of perception sensors, where the perception data represents an environment surrounding the vehicle and the environment includes a roadway the vehicle is traveling along. The one or more controllers determine a longitudinal incline of the roadway that vehicle is presently traveling along based on the perception data. The one or more controllers compare the longitudinal incline to a threshold incline value saved in memory, where the threshold incline value indicates the vehicle is traveling along a hill. In response to determining the longitudinal include is at least equal to the threshold incline value, the one or more controllers determine the vehicle is climbing a hill and instruct the contextual adaptive cruise control system to modify a behavior of the vehicle based on at least one of a target speed of the vehicle and an output torque of the prime mover of the vehicle.

In another aspect, the one or more controllers execute instructions to modify the behavior of the vehicle by reducing the target speed of the vehicle by a predefined threshold.

In yet another aspect, the one or more controllers execute instructions to determine the vehicle is at a first position at a toe of the hill based on the perception data from the plurality of perception sensors and in response to determining the vehicle is at the first position at the toe of the hill, reduce the target speed by the predefined threshold.

In an aspect, the one or more controllers receive map data via a communication network, where the map data indicates a distance between the first position at the toe of the hill and a second position at the top of the hill.

In another aspect, the one or more controllers execute instructions to reduce the target speed of the vehicle based on the distance between the first position at the toe of the hill and the second position at the top of the hill.

In yet another aspect, the one or more controllers execute instructions to modify the behavior of the vehicle by maintaining the target speed of the vehicle and allowing an actual speed of the vehicle to deviate from the target speed by a predefined threshold.

In an aspect, the one or more controllers execute instructions to determine the vehicle is at a first position at the toe of the hill based on the perception data from the plurality of perception sensors and in response to determining the vehicle is at the toe of the hill, allow the actual speed of the vehicle to deviate from the target speed by the predefined threshold until the vehicle reaches the bottom of the hill.

In another aspect, the predefined threshold ranges from about five percent to about ten percent of the target speed.

In another aspect, the one or more controllers execute instructions to modify the behavior of the vehicle based on the output torque of the prime mover, where the output torque of the vehicle is determined based on a plurality of driving objectives.

In yet another aspect, the plurality of driving objectives includes the riding comfort of one or more occupants of the vehicle, an energy efficiency of the prime mover, and the target speed of the vehicle while climbing the hill.

In an aspect, the one or more controllers store a riding comfort cost function, an energy efficiency cost function, and a target speed cost function in memory.

In another aspect, the riding comfort cost function is expressed as a function of the output torque of the prime mover and one or more environmental variables, the energy efficiency cost function is expressed as a function of the output torque of the prime mover and the one or more environmental variables, and the target speed cost function is expressed as a function of the output torque of the prime mover and the one or more environmental variables.

In yet another aspect, the one or more environmental variables include one or more of the following: a measured grade of the roadway, vehicle weight, a friction value of the roadway, the target speed, and driving habits of a driver of the vehicle.

In an aspect, the output torque of the prime mover is based on a weighted cost function that is the sum of the riding comfort cost function multiplied by a first weight value, the energy efficiency cost function multiplied by a second weight value, and the target speed cost function multiplied by a third weight value.

In another aspect, the one or more controllers minimize the weighted cost function based on a multi-objective optimization algorithm.

In yet another aspect, the multi-objective optimization is an a-priori multi-objective optimization algorithm.

In an aspect, the one or more controllers minimize the weighted cost function based on one or more machine learning algorithms.

In another aspect, the one or more machine learning algorithms include a deep neural network.

In yet another aspect, a method for modifying a behavior of a vehicle by a contextual adaptive cruise control system is disclosed. The method includes receiving, by one or more controllers, perception data from a plurality of perception sensors, where the perception data represents an environment surrounding the vehicle and the environment includes a roadway the vehicle is traveling along. The method includes determining a longitudinal incline of the roadway that vehicle is presently traveling along based on the perception data. The method includes comparing the longitudinal incline to a threshold incline value saved in memory, where the threshold incline value indicates the vehicle is traveling along a hill. In response to determining the longitudinal include is at least equal to the threshold incline value, the method includes determining the vehicle is climbing a hill. Finally, the method includes instructing the contextual adaptive cruise control system to modify a behavior of the vehicle based on at least one of a target speed of the vehicle and an output torque of a prime mover of the vehicle.

In an aspect, a contextual adaptive cruise control system for a vehicle is disclosed. The contextual adaptive cruise control system includes a prime mover, a plurality of perception sensors for collecting perception data representing an environment surrounding the vehicle, wherein the environment includes a roadway the vehicle is traveling along, and one or more controllers in electronic communication with the plurality of perception sensors. The one or more controllers execute instructions to receive the perception data from the plurality of perception sensors. The controllers determine a longitudinal incline of the roadway that vehicle is presently traveling along based on the perception data. The one or more controllers compare the longitudinal incline to a threshold incline value saved in memory, where the threshold incline value indicates the vehicle is traveling along a hill. In response to determining the longitudinal include is at least equal to the threshold incline value, the one or more controllers determine the vehicle is climbing a hill. Finally, the one or more controllers instruct the contextual adaptive cruise control system to modify a behavior of the vehicle based on at least one of a target speed of the vehicle and an output torque of the prime mover of the vehicle.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a vehicle including the disclosed contextual adaptive cruise control system including one or more controllers in electronic communication with a plurality of perception sensors, a prime mover, a braking system, and a communication network, according to an exemplary embodiment;

FIG. 2 is a block diagram of the software architecture of the one or more controllers shown in FIG. 1, according to an exemplary embodiment;

FIG. 3A is a graph illustrating a first option to modify the behavior of the vehicle based on the target speed, according to an exemplary embodiment;

FIG. 3B is a graph illustrating a second option to modify the behavior of the vehicle based on the target speed, according to an exemplary embodiment;

FIG. 4A is a graph illustrating one approach for controlling the actual speed of the vehicle based on map data, according to an exemplary embodiment; and

FIG. 4B is a graph illustrating another approach for controlling the actual speed of the vehicle based on map data, according to an exemplary embodiment.

### DETAILED DESCRIPTION

The following description is merely exemplary in nature and is not intended to limit the present disclosure, application, or uses.

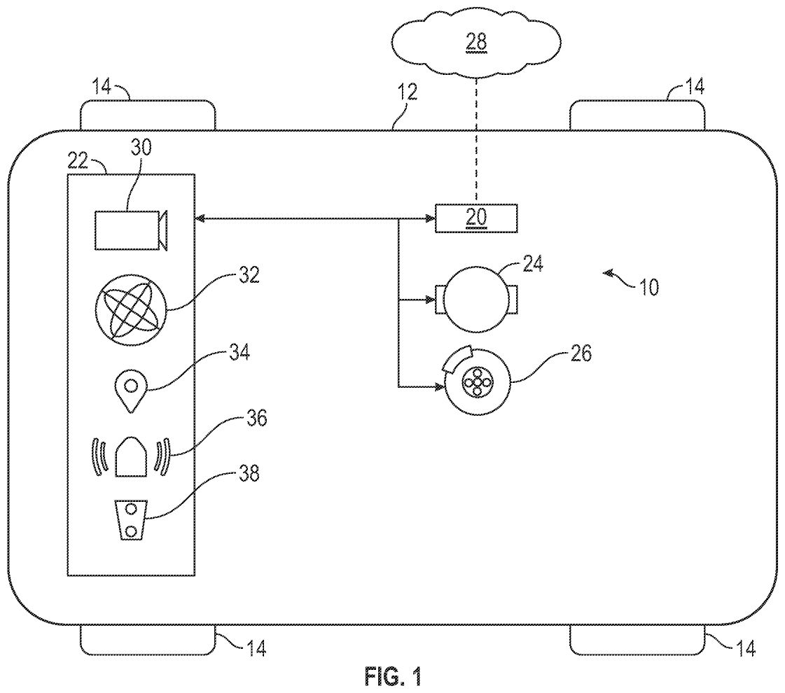

Referring to FIG. 1, a schematic diagram of an exemplary contextual adaptive cruise control system 10 for a vehicle 12 including a plurality of wheels 14 is illustrated. It is to be appreciated that the vehicle 12 may be any type of vehicle such as, but not limited to, a sedan, truck, sport utility vehicle, van, or motor home. In one embodiment, the contextual adaptive cruise control system 10 is part of an advanced driver-assistance system (ADAS) of the vehicle 12. The contextual adaptive cruise control system 10 includes one or more controllers 20 in electronic communication with a plurality of perception sensors 22, a prime mover 24, and a braking system 26. In embodiments, the one or more controllers 20 are also in wireless communication with one or more communication networks 28, where the one or more controllers 20 obtain map data of a roadway the vehicle 12 is presently traveling along via the communication network 28. Alternatively, the map data may be stored locally instead.

The plurality of perception sensors 22 are configured to collect perception data indicative of an environment surrounding the vehicle 12. The one or more controllers 20 determine contextual information regarding the roadway that the vehicle 12 is presently traveling along based on the perception data. Specifically, the contextual information of the roadway indicates a longitudinal incline of the roadway that vehicle 12 is presently traveling along. The longitudinal incline indicates the grade of the roadway. In an embodiment, the grade of the roadway may be expressed as a percentage (e.g., 100×rise/run). It is to be appreciated that the one or more controllers 20 determine the vehicle 12 is climbing a hill in response to determining the longitudinal incline of the roadway includes a positive incline for at least about five seconds, where the positive incline is at least a one-half percent grade. Similarly, the one or more controllers 20 determine the vehicle 12 is descending from a hill in response to determining the longitudinal incline of the roadway includes a negative incline for at least about five seconds, where the negative incline is at least a negative one-half percent grade. However, it is to be appreciated that the one-half percent grade and the period of time of at least about five seconds is exemplary in nature and may be adjusted based on the application.

In the non-limiting embodiment as shown in FIG. 1, the plurality of perception sensors 22 include one or more cameras 30, an inertial measurement unit (IMU) 32, a global positioning system (GPS) 34, radar 36, and LIDAR 38, however, is to be appreciated that additional sensors may be used as well. The one or more controllers 20 determine the grade of the roadway based on the linear acceleration, angular velocity, and magnetic field strength received by the IMU 32. The prime mover 24 represents a source of power that propels the vehicle 12 and includes an internal combustion engine, one or more electric motors, or a combination of an internal combustion engine and one or more electric motors. The braking system 26 includes a set of brakes corresponding to each wheel 14 of the vehicle 12.

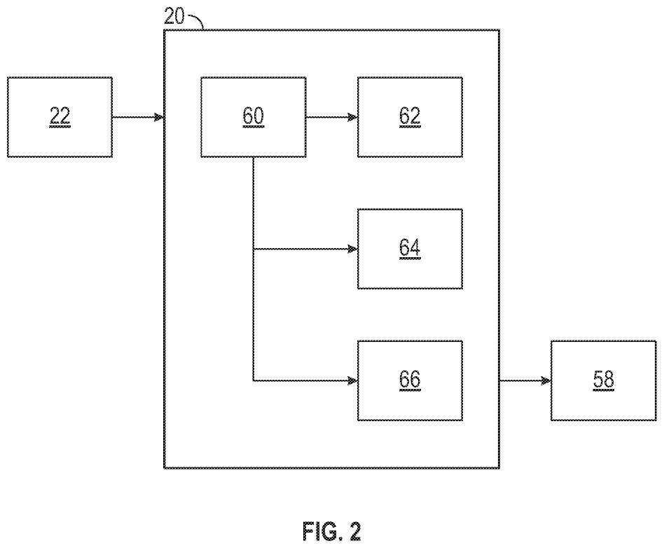

FIG. 2 is a block diagram illustrating a software architecture of the one or more controllers 20 of the contextual adaptive cruise control system 10 illustrated in FIG. 1. The one or more controllers 20 include a contextual module 60, a target speed module 62, an output torque module 64, and a downhill module 66. The contextual module 60 the one or more controllers 20 receives the perception data from the plurality of perception sensors 22 and determines the longitudinal incline of the roadway that vehicle 12 is presently traveling along based on the perception data. Specifically, the contextual module 60 of the one or more controllers 20 determines the grade of the roadway based on the linear acceleration, angular velocity, and magnetic field strength received by the IMU 32. The contextual module 60 compares the longitudinal incline to a threshold incline value saved in memory, where the threshold incline indicates the vehicle 12 is traveling along a hill. In one embodiment, the threshold incline value is a one percent grade. In response to determining the longitudinal incline is at least equal to the threshold incline value, the contextual module 60 determines the vehicle 12 is climbing a hill and instructs the contextual adaptive cruise control system 10 to modify a behavior of the vehicle 12 based on at least one of a target speed of the vehicle 12 and an output torque of the prime mover 24 of the vehicle 12 (FIG. 1). The one or more controllers 20 determine a longitudinal control command 58 instructing the vehicle 12 to accelerate or decelerate to achieve the behavior of the vehicle 12 as modified by the the contextual adaptive cruise control system 10. It is to be appreciated that the behavior of the vehicle 12 is based on the actual speed of the vehicle 12, an acceleration of the vehicle 12, and jerk experienced by the occupants. The actual speed of the vehicle 12, the acceleration, and the jerk are directly influenced by the output torque of the vehicle 12.

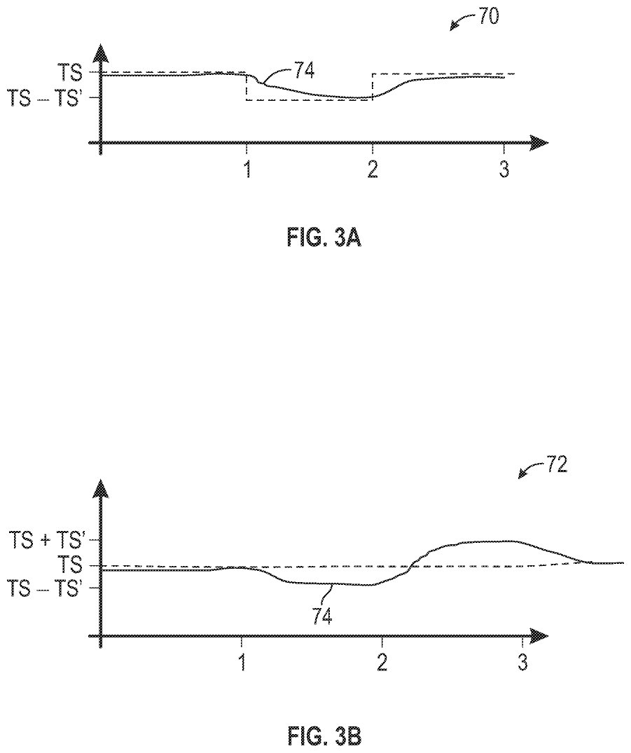

It is to be appreciated that modifying the behavior of the vehicle 12 based on the target speed generally improves the overall fuel or energy efficiency of the vehicle 12 when climbing a hill. Modifying the behavior of the vehicle 12 based on the output torque of the prime mover 24 generally improves overall riding comfort for the occupants of the vehicle 12 by reducing the occurrence of jerking as the vehicle 12 climbs a hill. Modifying the behavior of the vehicle 12 based on the target speed shall now be described. FIGS. 3A and 3B both include graphs 70, 72 illustrating different exemplary approaches to modify the behavior of the vehicle 12 based on the target speed. Specifically, FIG. 3A is a graph 70 illustrating a first option to modify the behavior of the vehicle 12 based on the target speed, where an x-axis of the graph 70 illustrates a position relative to a hill, the y-axis represents the vehicle speed, and the target speed is denoted as TS along the y-axis. FIG. 3B illustrates a graph 72 illustrating a second option to modify the behavior of the vehicle 12 based on the target speed. In the embodiments as shown in FIGS. 3A and 3B, the x-axis of the graphs 70, 72 indicate a first position 1 that is located along the start or a toe of the hill, a second position 2 at the top of the hill, and a third position 3 at the bottom of the hill where the hill terminates.

Referring to both FIGS. 2 and 3A, in one non-limiting embodiment the target speed module 62 of the one or more controllers 20 modifies the behavior of the vehicle 12 by reducing the target speed of the vehicle 12 by a predefined threshold TS′, where the predefined threshold TS' ranges from about five percent to about ten percent of the target speed TS. In the embodiment as shown in FIG. 3A, when the vehicle 12 is at the first position 1 at the toe of the hill, an actual speed 74 of the vehicle 12 is about equal to the target speed TS. The target speed module 62 determines the vehicle 12 is at the first position at the toe of the hill based on the perception data from the plurality of perception sensors 22. In response to determining the vehicle 12 is at the first position 1 at the toe of the hill, the target speed module 62 modifies the target speed TS by the predefined threshold TS′. As seen in FIG. 3A, an actual speed 74 of the vehicle 12 is reduced by the predefined threshold TS' by the time the vehicle 12 is at the second position 2 at the top of the hill. In response to determining the vehicle 12 is at the second position 2 at the top of the hill, the target speed module 62 instructs the vehicle 12 to continue traveling at the target speed TS. As seen in FIG. 3A, the actual speed 74 of the vehicle 12 is about equal to the target speed TS by the time the vehicle 12 is at the third position 3 at the bottom of the hill. However, it is to be appreciated that FIG. 3A is merely exemplary in nature, and in some instances the actual speed 74 of the vehicle 12 is equal to the target speed TS while the vehicle 12 is traveling down the hill, or after the vehicle 12 has reached the third position 3 at the bottom of the hill.

Referring to both FIGS. 2 and 3B, in another embodiment the target speed module 62 of the one or more controllers 20 modifies the behavior of the vehicle 12 by maintaining the target speed of the vehicle 12 and allowing the actual speed 74 of the vehicle 12 to deviate from the target speed TS by the predefined threshold TS′. In the embodiment as shown in FIG. 3B, the vehicle 12 is at the first position 1 at the toe of the hill, an actual speed of the vehicle 12 is about equal to the target speed TS. In response to determining the vehicle 12 is at the first position 1 at the toe of the hill, the target speed module 62 allows the actual speed 74 of the vehicle 12 to deviate from the target speed TS by the predefined threshold TS' until the vehicle 12 reaches the third position 3 at the bottom of the hill. Once the vehicle 12 reaches the third position 3 at the bottom of the hill, the target speed module 62 ceases to allow the actual speed 74 of the vehicle 12 to deviate from the target speed TS by the predefined threshold TS′.

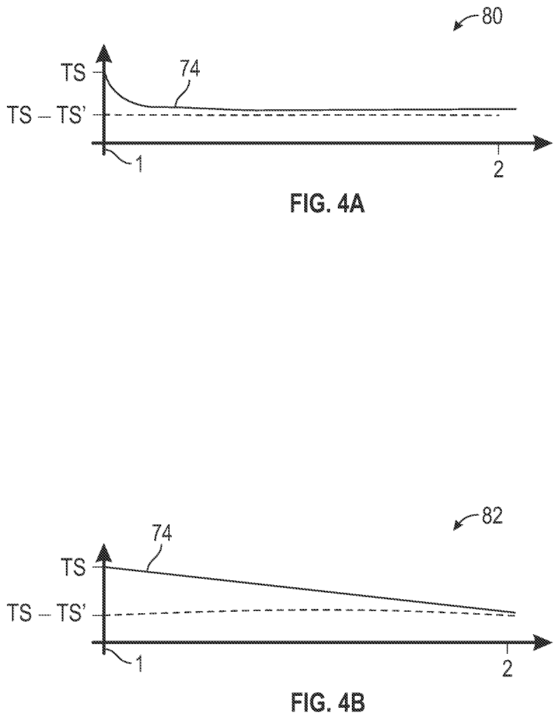

Referring to FIGS. 1, 2, and 3A, in embodiments the target speed module 62 of the one or more controllers 20 receives map data via the communication network 28. The map data indicates a distance between the first position 1 at the toe of the hill and the second position 2 at the top of the hill. If the distance between the first position 1 at the toe of the hill and the second position 2 at the top of the hill is known, the target speed module 62 of the one or more controllers 20 controls the actual speed 74 of the vehicle 12 between the first position 1 at the toe of the hill and the second position 2 at the top of the hill. Specifically, FIGS. 4A-4B illustrate two exemplary approaches to reduce the actual speed of the vehicle 12 when the distance between the first position 1 at the toe of the hill and the second position 2 at the top of the hill is known.

FIG. 4A illustrates a graph 80 illustrating one approach for controlling the actual speed 74 of the vehicle 12. Referring to both FIGS. 2 and 4A, in response to determining the vehicle 12 is at the first position 1 at the toe of the hill, the target speed module 62 reduces the actual speed 74 of the vehicle 12 by the predefined threshold TS' as quickly as possible while considering factors such as traffic and the speed limit, and before the vehicle 12 reaches the second position 2 at the top of the hill. As an example, the vehicle 12 controls the actual speed 74 according to the graph 80 by coasting down the hill at zero applied torque.

FIG. 4B illustrates a graph 82 illustrating another approach for controlling the actual speed 74 of the vehicle 12. Referring to both FIGS. 2 and 4B, in response to determining the vehicle 12 is at the first position 1 at the toe of the hill, the target speed module 62 steadily reduces the actual speed 74 of the vehicle 12 by the predefined threshold TS' so the actual speed 74 of the vehicle 12 is about equal to the predefined threshold TS' when the vehicle is at the second position 2 at the top of the hill. As seen in FIG. 4B, the actual speed 74 of the vehicle 12 is reduced gradually so a slope of the line representing the actual speed 74 of the vehicle 12 remains constant.

Referring to FIG. 2, modifying the behavior of the vehicle 12 based on the output torque of the prime mover 24 shall now be described. It is to be appreciated that the output torque module 64 of the one or more controllers 20 determines the output torque of the prime mover 24 based on a plurality of driving objectives. In one embodiment, the plurality of driving objectives include the riding comfort of one or more occupants of the vehicle 12, an energy efficiency of the prime mover 24 (FIG. 1), and the target speed of the vehicle 12 while climbing the hill. The riding comfort of the one or more occupants of the vehicle 12 is based on a maximum acceptable propulsion-induced acceleration value and a maximum acceptable jerk value as the vehicle 12 climbs the hill, where the maximum acceptable propulsion-induced acceleration value and the maximum acceptable jerk value are stored in the memory of the output torque module 64 of the one or more controllers 20.

In an embodiment, the maximum acceptable propulsion-induced acceleration value and the maximum acceptable jerk value are default values. It is to be appreciated that the default values may vary based on the vehicle type, since occupants of one type of vehicle may have a higher tolerance for jerk and propulsion-induced acceleration when compared to another type of vehicle, since some vehicles are specifically intended for activities that create a higher propulsion-induced acceleration and jerk. As an example, occupants of a sports car tend to have a higher tolerance for propulsion-induced acceleration and jerk when compared to the occupants of minivan or sedan. Therefore, the maximum acceptable propulsion-induced acceleration value and the maximum acceptable value may be higher for a sports car when compared to a minivan or a sedan. Alternatively, in another embodiment, the maximum acceptable propulsion-induced acceleration value and the maximum acceptable jerk value are adjusted based on occupant preferences. For example, in one embodiment, there may be gentle, medium, and high maximum acceptable propulsion-induced acceleration values and maximum acceptable jerk values based on the occupant preferences, since some individuals may be able to tolerate propulsion-induced acceleration and jerk more than other individuals.

It is to be appreciated that the driving objectives are each expressed as a unique cost function of the output torque of the prime mover 24 of the vehicle 12 and one or more environmental variables. Some examples of environmental variables include, but are not limited to, a measured grade of the roadway, vehicle weight, a friction value of the roadway, the target speed, and a driving style of an individual operating the vehicle 12. The driving style is inferred, for example, from driving maneuvers executed as the human driver of the vehicle 12 regains control of the vehicle 12 from autonomous or semi-autonomous driving, or from the way the human driver brakes and accelerates on flat and hilly roads. The output torque module 64 of the one or more controllers 20 stores a riding comfort cost function, an energy efficiency cost function, and a target speed cost function in the memory. The riding comfort cost function is expressed as a function of the output torque of the prime mover 24 and the one or more environmental variables. The riding comfort cost function corresponds to a difference between the current value of the propulsion-induced acceleration and the maximum acceptable propulsion-induced acceleration value and the difference between the current value of the jerk and the maximum acceptable jerk value. Similarly, the energy efficiency cost function is expressed as a function of the output torque of the prime mover 24 and the one or more environmental variables, where the energy efficiency cost function corresponds to the energy consumption of the prime mover 24. The target speed cost function is a function of the output torque of the prime mover 24 and the one or more environmental variables and corresponds to a difference in the actual speed and the target speed of the vehicle 12. It is to be appreciated that the output torque of the prime mover 24 is determined based on a weighted cost function that is the sum of the riding comfort cost function multiplied by a first weight value, the energy efficiency cost function multiplied by a second weight value, and the target speed cost function multiplied by a third weight value, where the weighted cost function is expressed in the following equation as:

Weighted Cost Function=w1×(riding comfort cost function)+w2×(energy efficiency cost function)+w3×(target speed cost function)

where w1, w2, and w3 are the first weight value, the second weight value, and the third weight value, respectively.

In one embodiment, the output torque module 64 of the one or more controllers 20 determines the output torque of the prime mover 24 by minimizing the weighted cost function. Specifically, the output torque module 64 determines a value of the output torque of the prime mover 24 that minimizes the weighted cost function based on a multi-objective optimization algorithm. Specifically, in one embodiment, the multi-objective optimization is an a-priori multi-objective optimization algorithm that is automated.f Alternatively, in another embodiment, the output torque module 64 of the one or more controllers 20 minimizes the weighted cost function based on one or more machine learning algorithms. Specifically, in one embodiment, the output torque module 64 of the one or more controllers 20 minimizes the weighted cost function based on a deep neural network.

Referring to FIGS. 1 and 2, in one embodiment the downhill module 66 of the one or more controllers 20 receives the perception data from the plurality of perception sensors 22 and determines the vehicle 12 has past the second position at the top of the hill and is presently traveling towards the third position at the bottom of the hill based on the perception data. In response to determining the vehicle 12 is traveling towards the third position at the bottom of the hill, the downhill module 66 modifies the behavior of the vehicle 12 by increasing the target speed by a tolerance window and allowing the vehicle 12 to coast down the hill until the actual speed of the vehicle 12 is equal to the target speed plus the tolerance window. In one non-limiting embodiment, the tolerance window is about 16 kilometers per hour (ten miles per hour). In response to determining the actual speed of the vehicle 12 is equal to the target speed plus the tolerance window, the downhill module 66 of the one or more controllers 20 instructs the braking system 26 to brake one or more sets of brakes of the wheels 14 of the vehicle 12 to reduce the actual speed of the vehicle 12. The actual speed of the vehicle 12 may be reduced to either the target speed or another speed as prescribed for collision avoidance. It is to be appreciated that allowing the vehicle 12 to coast above the target speed results in gaining momentum in an energy efficient manner before the vehicle 12 reaches the next ascending hill.

Referring generally to the figures, the disclosed contextual adaptive cruise control system provides various technical effects and benefits. Specifically, the disclosed contextual adaptive cruise control system provides an approach for enhancing occupant comfort and enhancing energy efficiency as the vehicle climbs a hill by modifying the behavior of the vehicle based on the target speed of the vehicle, the output torque of the prime mover of the vehicle, or both the target speed and the output torque. Modifying the behavior of the vehicle based on the target speed generally improves the overall energy efficiency of the vehicle, while modifying the behavior of the vehicle based on the output torque of the prime mover generally improves overall riding comfort for the occupants of the vehicle by reducing the occurrence of jerking as the vehicle climbs a hill. Furthermore, it is to be appreciated that the contextual adaptive cruise control system regulates the actual speed of the vehicle while climbing a hill without applying the brakes, which in turn improves energy efficiency.

The controllers may refer to, or be part of an electronic circuit, a combinational logic circuit, a field programmable gate array (FPGA), a processor (shared, dedicated, or group) that executes code, or a combination of some or all of the above, such as in a system-on-chip. Additionally, the controllers may be microprocessor-based such as a computer having at least one processor, memory (RAM and/or ROM), and associated input and output buses. The processor may operate under the control of an operating system that resides in memory. The operating system may manage computer resources so that computer program code embodied as one or more computer software applications, such as an application residing in memory, may have instructions executed by the processor. In an alternative embodiment, the processor may execute the application directly, in which case the operating system may be omitted.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A contextual adaptive cruise control system for a vehicle, wherein the vehicle includes a prime mover and a plurality of perception sensors, the contextual adaptive cruise control system comprising:
one or more controllers in electronic communication with the plurality of perception sensors and the prime mover, the one or more controllers executing instructions to:
receive perception data from the plurality of perception sensors, wherein the perception data represents an environment surrounding the vehicle and the environment includes a roadway the vehicle is traveling along;
determine a longitudinal incline of the roadway that vehicle is presently traveling along based on the perception data;
compare the longitudinal incline to a threshold incline value saved in memory, wherein the threshold incline value indicates the vehicle is traveling along a hill;
in response to determining the longitudinal include is at least equal to the threshold incline value, determine the vehicle is climbing a hill; and
instruct the contextual adaptive cruise control system to modify a behavior of the vehicle based on at least one of a target speed of the vehicle and an output torque of the prime mover of the vehicle.

2. The contextual adaptive cruise control system of claim 1, wherein the one or more controllers execute instructions to:
modify the behavior of the vehicle by reducing the target speed of the vehicle by a predefined threshold.

3. The contextual adaptive cruise control system of claim 2, wherein the one or more controllers execute instructions to:
determine the vehicle is at a first position at a toe of the hill based on the perception data from the plurality of perception sensors; and
in response to determining the vehicle is at the first position at the toe of the hill, reduce the target speed by the predefined threshold.

4. The contextual adaptive cruise control system of claim 3, wherein the one or more controllers receive map data via a communication network, wherein the map data indicates a distance between the first position at the toe of the hill and a second position at the top of the hill.

5. The contextual adaptive cruise control system of claim 4, wherein the one or more controllers execute instructions to:
reduce the target speed of the vehicle based on the distance between the first position at the toe of the hill and the second position at the top of the hill.

6. The contextual adaptive cruise control system of claim 1, wherein the one or more controllers execute instructions to:
modify the behavior of the vehicle by maintaining the target speed of the vehicle and allowing an actual speed of the vehicle to deviate from the target speed by a predefined threshold.

7. The contextual adaptive cruise control system of claim 6, wherein the one or more controllers execute instructions to:
determine the vehicle is at a first position at the toe of the hill based on the perception data from the plurality of perception sensors; and
in response to determining the vehicle is at the toe of the hill, allow the actual speed of the vehicle to deviate from the target speed by the predefined threshold until the vehicle reaches the bottom of the hill.

8. The contextual adaptive cruise control system of claim 6, wherein the predefined threshold ranges from about five percent to about ten percent of the target speed.

9. The contextual adaptive cruise control system of claim 1, wherein the one or more controllers execute instructions to:
modify the behavior of the vehicle based on the output torque of the prime mover, wherein the output torque of the vehicle is determined based on a plurality of driving objectives.

10. The contextual adaptive cruise control system of claim 9, wherein the plurality of driving objectives include a riding comfort of one or more occupants of the vehicle, an energy efficiency of the prime mover, and the target speed of the vehicle while climbing the hill.

11. The contextual adaptive cruise control system of claim 10, wherein the one or more controllers store a riding comfort cost function, an energy efficiency cost function, and a target speed cost function in memory.

12. The contextual adaptive cruise control system of claim 11, wherein the riding comfort cost function is expressed as a function of the output torque of the prime mover and one or more environmental variables, the energy efficiency cost function is expressed as a function of the output torque of the prime mover and the one or more environmental variables, and the target speed cost function is expressed as a function of the output torque of the prime mover and the one or more environmental variables.

13. The contextual adaptive cruise control system of claim 12, wherein the one or more environmental variables include one or more of the following: a measured grade of the roadway, vehicle weight, a friction value of the roadway, the target speed, and driving habits of a driver of the vehicle.

14. The contextual adaptive cruise control system of claim 12, wherein the output torque of the prime mover is based on a weighted cost function that is the sum of the riding comfort cost function multiplied by a first weight value, the energy efficiency cost function multiplied by a second weight value, and the target speed cost function multiplied by a third weight value.

15. The contextual adaptive cruise control system of claim 14, wherein the one or more controllers minimize the weighted cost function based on a multi-objective optimization algorithm.

16. The contextual adaptive cruise control system of claim 15, wherein the multi-objective optimization is an a-priori multi-objective optimization algorithm.

17. The contextual adaptive cruise control system of claim 14, wherein the one or more controllers minimize the weighted cost function based on one or more machine learning algorithms.

18. The contextual adaptive cruise control system of claim 17, wherein the one or more machine learning algorithms include a deep neural network.

19. A method for modifying a behavior of a vehicle by a contextual adaptive cruise control system, the method comprising:
receiving, by one or more controllers, perception data from a plurality of perception sensors, wherein the perception data represents an environment surrounding the vehicle and the environment includes a roadway the vehicle is traveling along;
determining a longitudinal incline of the roadway that vehicle is presently traveling along based on the perception data;
comparing the longitudinal incline to a threshold incline value saved in memory, wherein the threshold incline value indicates the vehicle is traveling along a hill;
in response to determining the longitudinal include is at least equal to the threshold incline value, determining the vehicle is climbing a hill; and
instructing the contextual adaptive cruise control system to modify a behavior of the vehicle based on at least one of a target speed of the vehicle and an output torque of a prime mover of the vehicle.

20. A contextual adaptive cruise control system for a vehicle, the contextual adaptive cruise control system comprising:
a prime mover;
a plurality of perception sensors for collecting perception data representing an environment surrounding the vehicle, wherein the environment includes a roadway the vehicle is traveling along; and
one or more controllers in electronic communication with the plurality of perception sensors, the one or more controllers executing instructions to:
receive the perception data from the plurality of perception sensors;
determine a longitudinal incline of the roadway that vehicle is presently traveling along based on the perception data;
compare the longitudinal incline to a threshold incline value saved in memory, wherein the threshold incline value indicates the vehicle is traveling along a hill;
in response to determining the longitudinal include is at least equal to the threshold incline value, determine the vehicle is climbing a hill; and
instruct the contextual adaptive cruise control system to modify a behavior of the vehicle based on at least one of a target speed of the vehicle and an output torque of the prime mover of the vehicle.
